(19) United States
(12) Patent Application Publication
(10) Pub. No.: US 2009/0165657 A1
(43) Pub. Date: Jul. 2, 2009

(54) Cooking Appliance

(75) Inventor: Xiaoli Cheng, Fujian (CN)

Correspondence Address: KENING LI;PINSENT MASONS, c/o BAKER DONELSON BEARMAN CALDWELL& BERKOWITZ, PC, 555 ELEVENTH STREET, NW, SIXTH FLOOR, WASHINGTON, DC, 20004, US

(73) Assignee: TSANN KUEN (CHINA) ENTERPRISE CO., LTD., Fujian (CN)

(21) Appl. No.: 12/249,383

(22) Filed: Oct. 10, 2008

(30) Foreign Application Priority Data
Oct. 10, 2007 (CN) 200720008463.8

(51) Int. Cl. A47J 27/00

(52) U.S. Cl. 99/443 R

(57) ABSTRACT

A cooking appliance comprises a supporting base unit and a cooking assembly. The supporting base unit comprises two substantially parallel supporting frames, and the top of each supporting frame forms a supporting seat. Two sides of the cooking assembly have pivot parts, and the cooking assembly is set between the two supporting frames. The two pivot parts are rotatably connected to the two supporting frames respectively. The cooking assembly of the cooking appliance can circumrotate discretionarily from 0° to 360° on the supporting frames. The present invention overcomes the disadvantages of the related art and has the advantages of allowing food to be roasted evenly and to be more healthful.

### FIELD OF THE INVENTION

The invention involves a cooking appliance, more particularly to a cooking appliance with a rotatable cooking assembly.

### RELATED ART

Known cooking appliances usually adopt a direct contact heat mode with no circumrotating. Because such cooking appliances cannot circumrotate, grease and food debris etc. gather on or near the cooking plate of the cooking appliance, making roasted food to be heated unevenly and the surface of roasted food to have burnt spots and a poor appearance. In addition, chemicals such as burnt oil effusing from the cooking plate make the roasted food from these appliances unhealthy.

### SUMMARY OF THE INVENTION

The present invention provides a cooking appliance which overcomes the disadvantages of existing cooking assemblies that cannot be circumrotated.

The present invention adopts a technical solution to overcome the shortcomings as follows. The cooking appliance comprises a supporting base unit and a cooking assembly. The supporting base unit comprises two substantially parallel supporting frames, and the top of each supporting frame forms a supporting seat. Two sides of the cooking assembly have pivot parts, and the cooking assembly is set between the two supporting frames, and the pivot parts are rotatably connected to the two supporting frames, respectively.

According to a preferred embodiment of the present invention, the first pivot part comprises a first revolving shaft unit that is installed at a first side of the cooking assembly. A first pivot hole is set on the top of the first supporting frame, and the first revolving shaft unit is pivoted to the first pivot hole.

According to a preferred embodiment of the present invention, the cooking appliance also comprises a handle unit that is fixed to a first revolving shaft unit detachably.

According to a preferred embodiment of the present invention, the cooking assembly comprises an upper cooking unit and a lower cooking unit. The first revolving shaft unit comprises an upper revolving shaft that is connected to the upper cooking unit and a lower revolving shaft that is connected to the lower cooking unit. A top surface of the upper revolving shaft is a circular arc and the bottom surface of the lower revolving shaft is a circular arc, wherein the upper revolving shaft and the lower revolving shaft cooperate with each other. The upper arc surface and the lower arc surface have the same diameter and are coaxial.

According to a preferred embodiment of the present invention, the handle unit comprises an upper handle and a lower handle that is fixed to the upper handle detachably. The upper handle and the lower handle clamp the first revolving shaft unit detachably.

According to a preferred embodiment of the present invention, the second pivot part comprises a second revolving shaft unit that is installed at a second side of the cooking assembly. A second pivot hole is set on the top of the second supporting frame. The second revolving shaft unit is pivoted to the second pivot hole.

According to a preferred embodiment of the present invention, the cooking assembly comprises the upper cooking unit and the lower cooking unit. The second revolving shaft unit comprises an upper decoration board that is installed on the top surface of the upper cooking unit. A lower decoration board is installed on the bottom surface of the lower cooking unit and a right revolving shaft that is installed on the lower decoration board. The bottom surface of the lower decoration board is a circular arc. The top surface of the right revolving shaft is a circular arc, wherein the lower decoration board and the right revolving shaft cooperate with each other. The upper arc surface and the lower arc surface have the same diameter and are coaxial.

According to a preferred embodiment of the present invention, the supporting base unit also comprises a base and an oil storage tray, the base is fixed between bottoms of the two supporting frames detachably, and the oil storage tray is set above the base and just below the cooking assembly.

According to a preferred embodiment of the present invention, the end of the second side of the upper cooking unit is pivoted to the end of the second side of the lower cooking unit.

As a result of the cooking assembly, the invention can circumrotate freely from 0° to 360° on the supporting frames. The present invention overcomes the disadvantages of related art and has advantages as follows: first, food can be roasted evenly; second, grease of food can effuse easily to make the food more healthful. The handle unit is fixed to the first revolving shaft unit detachably so that users can circumrotate, freely and at will, the food roasting assembly from 0° to 360° by circumrotating the handle unit manually.

### BRIEF DESCRIPTION OF THE DRAWINGS

The present invention will be further described according to the drawings and the embodiment.

FIG. 1 is an exploded view according to a preferred embodiment of the cooking appliance of the present invention.

FIG. 2 is a front view according to a preferred embodiment of the cooking appliance at 0° of the present invention.

FIG. 3 is a front view according to a preferred embodiment of the cooking appliance at 45° of the present invention.

FIG. 4 is a front view according to a preferred embodiment of the cooking appliance at 90° of the present invention.

FIG. 5 is a front view according to a preferred embodiment of the cooking appliance at 180° of the present invention.

FIG. 6 is a front view according to a preferred embodiment of the cooking appliance at 225° of the present invention.

### DETAILED DESCRIPTION OF THE PREFERRED EMBODIMENTS

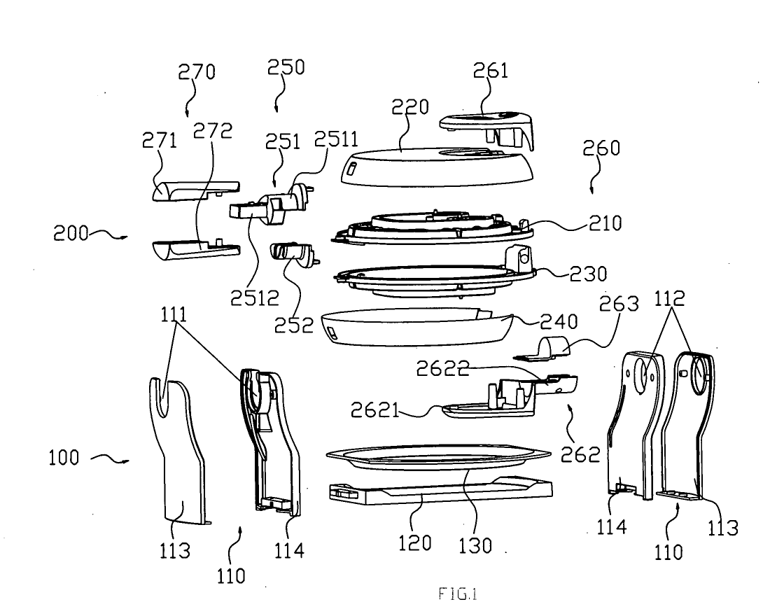

Referring to FIG. 1, it is an exploded view according to a preferred embodiment of the cooking appliance of the present invention. The cooking appliance comprises a supporting base unit 100 and a cooking assembly 200.

The supporting base unit 100 comprises two supporting frames 110, a base 120 and an oil storage tray 130. Each supporting frame 110 comprises a first shell 113 and a second shell 114, and the first shell 113 is fixed to the second shell 114. A top of the first supporting frame 110 forms a supporting seat, namely, first pivot hole 111 with an open top. A top of the second supporting frame 110 forms supporting seat, namely, second pivot hole 112. The base 120 is fixed between bottoms of the two supporting frames 110 detachably and makes the two supporting frames 110 be substantially parallel with each other and be upright. The oil storage tray 130 is set above the base 120.

The cooking assembly 200 comprises an upper cooking unit and a lower cooking unit. A right end of the upper cooking unit is pivoted to a right end of the lower cooking unit, and there is an oil leakage hole 280 formed between them. The upper cooking unit comprises an upper cooking plate 210 and an upper shell 220 that is fixed to the upper cooking plate 210, and the lower cooking unit comprises a lower cooking plate 230 and a lower shell 240 that is fixed to the lower cooking plate 230. For example, cooking plates are designed according to normal thickness of hamburger: the thickness of each cooking plate is 1.5 mm, the height of the raised grilling ribs of the cooking plate is 2.5 mm, and the width of the raised grilling ribs of the cooking plate is 5.7 mm, and the center distance of two raised grilling ribs is 14 mm. When the upper cooking plate and the lower cooking plate are closed, the raised grilling ribs on the upper cooking plates and the raised grilling ribs on the lower cooking plate are interlaced with each other, and the distance between the two cooking plates is 14.2 mm, which can make sure that the hamburger will not be clamped or shake in the cooking plates. There is a first pivot part 250 at the left side of the cooking assembly 200, and there is a second pivot part 260 at the right side of the cooking assembly 200.

The first pivot part 250 comprises a first revolving shaft unit, which comprises an upper revolving shaft 251 that engages with the upper cooking unit detachably and a lower revolving shaft 252 that engages with the lower cooking unit detachably. The upper revolving shaft 251 has an arc piece 2511 and an orientation piece 2512 that is fixed to an end of the arc piece 2511, and a top surface of the arc piece 2511 is circular arc. A bottom surface of the lower revolving shaft 252 is circular arc. The upper revolving shaft 251 engages with the lower revolving shaft 252, and the arc surface of the arc piece 2511 and the arc surface of lower revolving shaft 252 have the same diameter and are coaxial to form a first pivot column surface; the first pivot column surface of the first pivot part 250 is pivoted to the first pivot hole 111 of the first supporting frame 110. The orientation piece 2512 gets through the first pivot hole 111 of the first supporting frame 110 and comes out of the left side of the first supporting frame 110. In addition, there is a handle unit 270, which comprises an upper handle 271 and a lower handle 272 that is fixed to the upper handle 271 detachably. The upper handle and the lower handle clamp the orientation piece 2512 of the first revolving shaft unit detachably. The handle unit 270, the first revolving shaft unit and the cooking assembly 200 form fixed connection detachably.

The second pivot part 260 comprises a second revolving shaft unit, which comprises an upper decoration board 261, a lower decoration board 262 and a right revolving shaft 263. The upper decoration board 261 is installed on the top surface of the upper cooking unit detachably, and the lower decoration board 262 is installed on the bottom surface of the lower cooking unit. The lower decoration board 262 has a lower fixed board 2621 and an arc piece 2622 that is fixed to the lower fixed board 2621. A bottom surface of the arc piece 2622 is circular arc, and a top surface of the right revolving shaft 263 is circular arc. The right revolving shaft 263 engage with the arc piece 2622 to make the arc surface of arc piece 2622 and the arc surface of the right revolving shaft 263 have the same diameter and be coaxial to form a second pivot column surface. The second pivot column surface of the second pivot part 260 is pivoted to the second pivot hole 112 of the second supporting frame 110.

The first pivot part and the second pivot part of above cooking assembly 200 are pivoted to the two supporting frames 110 to make the cooking assembly 200 be connected rotationally between the two supporting frames 110, and the cooking assembly 200 is just above the oil storage tray 130.

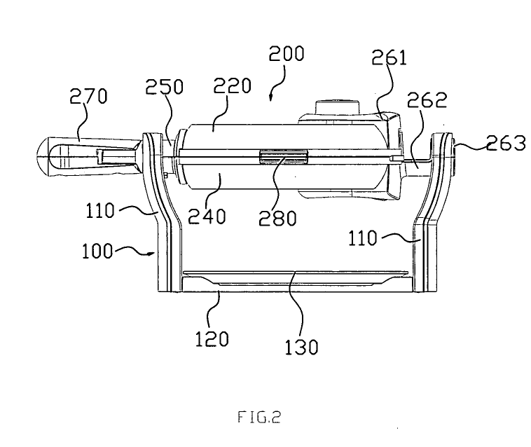

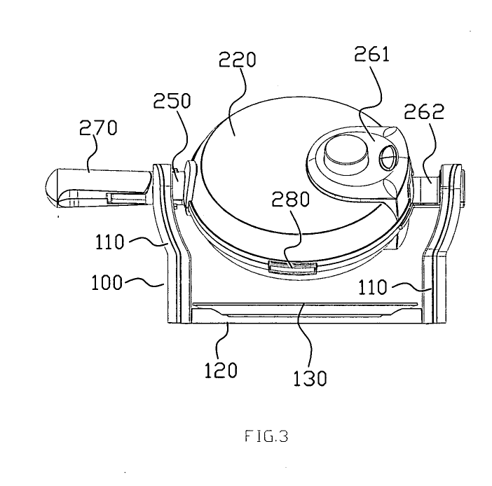

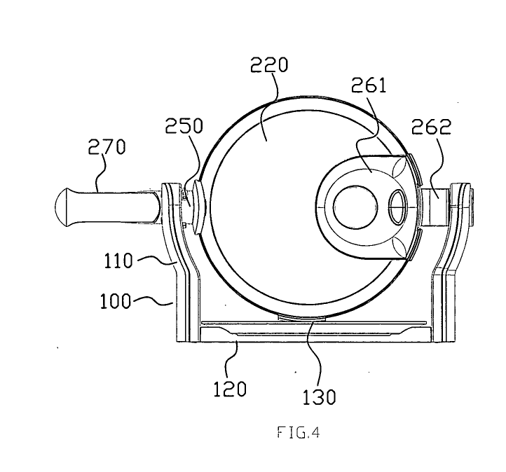

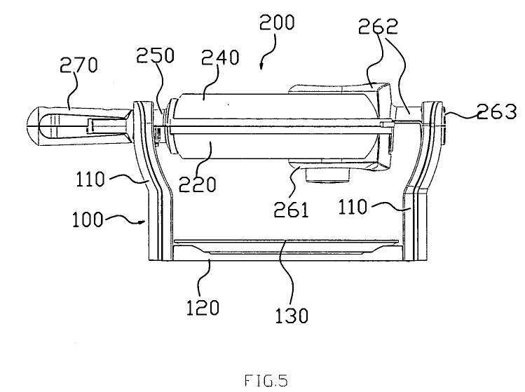

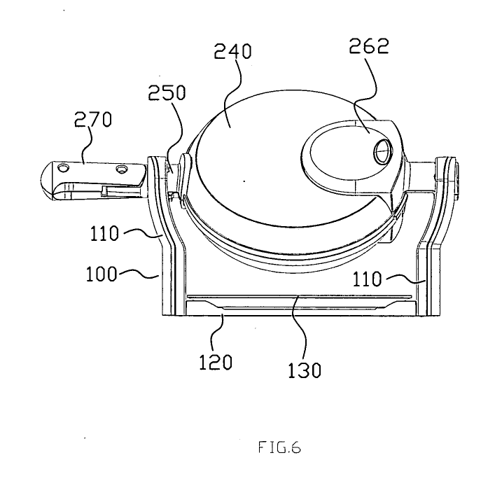

Referring to FIGS. 2, 3, 4, 5 and 6, which are front views according to a preferred embodiment of the cooking appliance at 0/45/90/180/225° of the present invention. Wherein, at 90° the cooking appliance has a good oil effusing, which can make unwanted grease of food stream along the oil leakage hole 280 at the side of the cooking assembly and drip into the oil storage tray 130, and so the roasted food is healthy to eat; two surfaces of food can be heated uniformly to make roasted food have an absorbing appearance. In roasting thin sliced meat the cooking appliance of the present invention can be circumrotated for 180°, and so the sliced meat can be roasted to avoid that grease of food and caloric of cooking units gather in the lower cooking unit and roasted food has burnt points and a bad appearance.

The foregoing description of the exemplary embodiment of the invention has been presented for the purposes of illustration and description. It is not intended to be exhaustive or to limit the invention to the precise form disclosed. Many modifications and variations are possible in light of the above teaching. All changes that come within the meaning and range of equivalency of the claims are to be embraced within their scope.

What is claimed is:

1. A cooking appliance, comprising
a supporting base unit, which comprises a first supporting frame and a second supporting frame, wherein the first and second supporting frames are parallel to each other, and the top of each supporting frame forms a supporting seat; and
a cooking assembly with a first side having a first pivot part, and a second side having a second pivot part, wherein the cooking assembly is set between the two supporting frames, and the first and second pivot parts are rotatably connected to the two supporting frames respectively.

2. The cooking appliance according to claim 1, wherein the first pivot part comprises a first revolving shaft unit that is installed at the first side of the cooking assembly, a first pivot hole is formed on the top of the first supporting frame, and the first revolving shaft unit is pivoted to the first pivot hole.

3. The cooking appliance according to claim 2 further comprising a handle unit that is fixed to the first revolving shaft unit detachably.

4. The cooking appliance according to claim 3, wherein the cooking assembly comprises an upper cooking unit and a lower cooking unit; the first revolving shaft unit comprises an upper revolving shaft that is connected to the upper cooking unit and a lower revolving shaft that is connected to the lower cooking unit; a top surface of the upper revolving shaft is a circular arc and the bottom surface of the lower revolving shaft is a circular arc, the upper revolving shaft and the lower revolving shaft cooperate with each other, and the upper arc surface and the lower arc surface have the same diameter and are coaxial.

5. The cooking appliance according to claim 4, wherein the handle unit comprises an upper handle and a lower handle, wherein the lower handle that is fixed to the upper handle detachably, and the upper handle and the lower handle clamp the first revolving shaft unit detachably.

6. The cooking appliance according to claim 1, wherein the second pivot part comprises a second revolving shaft unit that is installed at a second side of the cooking assembly, a second pivot hole is formed on the top of the second supporting frame, and the second revolving shaft unit is pivoted to the second pivot hole.

7. The cooking appliance according to claim 6, wherein the cooking assembly comprises an upper cooking unit and the lower cooking unit; the second revolving shaft unit comprises an upper decoration board that is installed on the top surface of the upper cooking unit, a lower decoration board that is installed on the bottom surface of the lower cooking unit and a right revolving shaft that is installed on the lower decoration board; a bottom surface of the lower decoration board is a circular arc, and a top surface of the right revolving shaft is a circular arc, wherein the lower decoration board and the right revolving shaft cooperate with each other and the upper arc surface and the lower arc surface have the same diameter and are coaxial.

8. The cooking appliance according to claim 1, wherein the supporting base unit further comprises a base and an oil storage tray, wherein the base is fixed between bottoms of the two supporting frames detachably, and the oil storage tray is set above the base and just below a meat roasting assembly.

9. The cooking appliance according to claim 4, wherein the end of the second side of the upper cooking unit is pivoted to the end of the second side of the lower cooking unit.
